(19) United States
(12) Patent Application Publication
(10) Pub. No.: US 2025/0337697 A1
(43) Pub. Date: Oct. 30, 2025

(54) IN-LINK FLIT RESIZING WITH END-TO-END CREDITS

(71) Applicant: Baya Systems, Inc., Santa Clara, CA (US)

(72) Inventors: Jatinkumar Vithalbhai Fultaria, Bengaluru (IN); James Aldis, Northampton (GB); Joji Philip, San Jose, CA (US); Avinash Jagdish Patil, Bangalore (IN)

(21) Appl. No.: 18/744,454

(22) Filed: Jun. 14, 2024

(30) Foreign Application Priority Data
Apr. 24, 2024 (IN) 202411032476

(51) Int. Cl. H04L 49/25; H04L 49/109

(52) U.S. Cl. CPC H04L 49/251; H04L 49/109

(57) ABSTRACT

Systems and methods involving a wide-to-narrow in-link converter for Network on Chip (NoC). The converter processes wide flits from the source router, transforming the wide flits into multiple narrow flits efficiently popped to the destination router. A link credit is returned to the source router post-transfer. The converter also handles diverse wide flit types, converting and popping the wide flit types accordingly. Additionally, a narrow-to-wide converter accumulates and converts narrow flits into wide flits, optimizing communication efficiency in the NoC and overcoming traditional limitations.

### CROSS REFERENCE TO RELATED APPLICATION

This application claims the benefit of and priority to India application Ser. No. 20/241,1032476, entitled “IN-LINK FLIT RESIZING WITH END-TO-END CREDITS” and filed on Apr. 24, 2024, which is expressly incorporated by reference herein in its entirety.

### TECHNICAL FIELD

Methods and example embodiments described herein are generally directed to width adaption converter for communication between routers of a Network on Chip (NoC).

### RELATED ART

The number of components on a chip is rapidly growing due to increasing levels of integration, system complexity and shrinking transistor geometry. Complex System-on-Chips (SoCs) may involve a variety of components e.g., processor cores, Digital Signal processors (DSPs), hardware accelerators, memory and Input/Output (I/O), while Chip Multi-Processors (CMPs) may involve a large number of homogenous processor cores, memory and I/O subsystems. In both systems the on-chip interconnect plays a key role in providing high-performance communication between the various components. Due to scalability limitations of traditional buses and crossbar-based interconnects, Network-on-Chip (NoC) has emerged as a paradigm to interconnect a large number of components on the chip.

NoC is a global shared communication infrastructure made up of several routing nodes interconnected with each other using point-to-point physical links. Messages are injected by the source component and are routed from the source components to the destination over multiple intermediate nodes and physical links. The destination component then ejects the message and provides it to the destination component. For the remainder of the document, terms ‘components’, ‘blocks’ ‘hosts’ or ‘cores’ will be used interchangeably to refer to the various system components which are interconnected using a NoC. Terms ‘routers’ and ‘nodes’ will also be used interchangeably. Without loss of generalization, the system with multiple interconnected components will itself be referred to as ‘multi-core system’.

There are several possible topologies in which the routers can connect to one another to create the system network. Bi-directional rings 100A (as shown in FIG. 1A) and 2-D mesh 100B (as shown in FIG. 1B) are examples of topologies in the related art.

Packets are message transport units for intercommunication between various components. Routing involves identifying a path which is a set of routers and physical links of the network over which packets are sent from a source to a destination. Components are connected to one or multiple ports of one or multiple routers; with each such port having a unique identifier (ID). Packets carry the destination's router and port ID for use by the intermediate routers to route the packet to the destination component.

Examples of routing techniques include deterministic routing, which involves choosing the same path from A to B for every packet. This form of routing is oblivious of the state of the network and does not load balance across path diversities which might exist in the underlying network. However, such deterministic routing may be simple to implement in hardware, maintains packet ordering and may be easy to make free of network level deadlocks. Shortest path routing minimizes the latency as it reduces the number of hops from the source to destination. For this reason, the shortest path is also the lowest power path for communication between the two components. Dimension-order routing is a form of deterministic shortest path routing in 2D mesh networks.

FIG. 2 illustrates an example of XY routing 200 in a two-dimensional mesh. More specifically, FIG. 2 illustrates XY routing from node ‘34’ to node ‘00’. In the example of FIG. 2, each component is connected to only one port of one router. A packet is first routed in the X dimension till the packet reaches node ‘04’ where the x dimension is same as destination. The packet is next routed in the Y dimension until the packet reaches the destination node.

Source routing and routing using tables are other routing options used in NoC. Adaptive routing can dynamically change the path taken between two points on the network based on the state of the network. This form of routing may be complex to analyze and implement and is therefore rarely used in practice.

A NoC may contain multiple physical networks. Over each physical network, there may exist multiple virtual networks, wherein different messages are transmitted over different virtual networks. In this case, at each physical link or channel, there are multiple virtual channels; each virtual channel may have dedicated buffers at both end points. In any given clock cycle, only one virtual channel can transmit data on the physical channel.

NoC interconnects often employ wormhole routing, wherein, a large message or packet is broken into small pieces known as flits (also referred to as flow control units). The first flit is the header flit which holds information about this packet's route and key message level info along with payload data and sets up the routing behavior for all subsequent flits associated with the message. Zero or more body flits follows the head flit, containing the remaining payload of data. The final flit is tail flit which in addition to containing the last payload also performs some bookkeeping to close the connection for the message. The header flit and first body flit may be sent in parallel to increase the bandwidth of the system at the expense of more wires. In wormhole flow control, virtual channels are often implemented.

The physical channels are time sliced into a number of independent logical channels called virtual channels (VCs). VCs provide multiple independent paths to route packets; however, they are time-multiplexed on the physical channels. A virtual channel holds the state needed to coordinate the handling of the flits of a packet over a channel. At a minimum, this state identifies the output channel of the current node for the next hop of the route and the state of the virtual channel (idle, waiting for resources, or active). The virtual channel may also include pointers to the flits of the packet that are buffered on the current node and the number of flit buffers available on the next node.

The term “wormhole” plays on the way messages are transmitted over the channels: the output port at the next router can be so close that received data can be translated in the head flit before the full message arrives. This allows the router to quickly set up the route upon arrival of the head flit and then opt out from the rest of the conversation. Since a message is transmitted flit by flit, the message may occupy several flit buffers along its path at different routers, creating a worm-like image of the packet head moving forward toward its destination and the rest of the packet flits following as a worm's body follows the worm head.

Based upon the traffic between various end points, and the routes and physical networks that are used for various messages, different physical channels of the NoC interconnect may experience different levels of load and congestion. The capacity of various physical channels of a NoC interconnect is determined by the width of the channel (number of physical wires) and the clock frequency at which it is operating. Various channels of the NoC may operate at different clock frequencies. However, in many related art implementations, all channels are equal in width or number of physical wires. This width can be determined based on the most loaded channel and the clock frequency of various channels.

### SUMMARY

Aspects of the example implementations may include a method, involving receiving a wide flit from the source router and converting the wide flit to a plurality of narrow flits for popping the plurality of narrow flits to the destination router. Further, the method includes returning a link credit to the source router and accumulating narrow flit credits received from the destination router. Further, the method includes returning a wide flit credit to the source router for when a number of the accumulated narrow flit credits is equivalent to the wide flit credit.

Additional aspects of the example implementations may further include a system, which includes a wide to narrow in-link converter is configured to receive a wide flit from a source router and convert the wide flit to a plurality of narrow flits to pop the plurality of narrow flits to the destination router. Further, the wide to narrow in-link converter is configured to return a link credit to the source router and accumulate narrow flit credits received from the destination router. Further, the wide to narrow in-link converter is configured to return a wide flit credit to the source router for when a number of the accumulated narrow flit credits is equivalent to the wide flit credit.

Additional aspects of the example implementations may include a method, involving transmitting, from the source router, a first type of wide flit or a second type of wide flit to a wide-to-narrow in-link converter, the first type of wide flit being different from the second type of wide flit and converting, at the wide-to-narrow in-link converter, the first type of wide flit to a plurality of narrow flits for popping the plurality of narrow flits to the destination router.

Additional aspects of the example implementations may further include a system, which includes a wide to narrow in-link converter is configured to receive a first type of wide flit or a second type of wide flit from the source router, the first type of wide flit being different from the second type of wide flit and convert, at the wide-to-narrow in-link converter, the first type of wide flit to a plurality of narrow flits to pop the plurality of narrow flits to the destination router.

Additional aspects of the example implementations may include a method, involving receiving a first wide flit from the source router and converting the first wide flit to a plurality of narrow flits and storing the plurality of narrow flits into a buffer for popping to the destination router. Further, for each subsequent wide flit received from the source router, the method includes for the buffer not being empty, popping a narrow flit from the plurality of narrow flits to the destination router and discarding the subsequent wide flit and for the buffer being empty, converting the subsequent wide flit into another plurality of narrow flits and storing another plurality of narrow flits into the buffer.

Additional aspects of the example implementations may further include a system, which includes a wide to narrow in-link converter is configured to receive a first wide flit from the source router and convert the first wide flit to a plurality of narrow flits and storing the plurality of narrow flits into a buffer for popping to the destination router. Further, the wide to narrow in- link converter is configured to pop a narrow flit from the plurality of narrow flits to the destination router and discarding the subsequent wide flit, for the buffer not being empty. Further, the wide to narrow in-link converter is configured to convert the subsequent wide flit into another plurality of narrow flits and storing another plurality of narrow flits into the buffer, for the buffer being empty.

Additional aspects of the example implementations may include a method, involving accumulating narrow flits from the source router and converting the accumulated narrow flits into a wide flit based on the narrow flits accumulated for popping the wide flit to the destination router.

Additional aspects of the example implementations may further include a system, which includes a narrow-to-wide converter configured to accumulate narrow flits from the source router and convert the accumulated narrow flits into a wide flit based on the narrow flits accumulated to pop the wide flit to the destination router.

### BRIEF DESCRIPTION OF THE DRAWINGS

FIGS. 1A and 1B illustrate examples of Bidirectional ring and 2D Mesh Network-on-Chip (NoC) Topologies.

FIG. 2 illustrates an example of XY routing in a related art two-dimensional mesh.

FIG. 3 illustrates a schematic representation of a buffer-based wide-to-narrow flits converter positioned between a source router and a destination router.

FIG. 4(a) illustrates a schematic representation of a wide-to-narrow converter positioned between the source router and the destination router where narrow credits are sent from the destination router to the source router, in accordance with an example implementation.

FIG. 4(b) illustrates a schematic representation of the wide-to-narrow converter positioned between the source router and the destination router where narrow credits are sent from the destination router to the converter, in accordance with an example implementation.

FIG. 4(c) illustrates a schematic representation of a narrow-to-wide converter positioned between the source router and the destination router, in accordance with an example implementation.

FIGS. 5(a), 5(b), and 5(c) illustrate flowcharts of methods for the wide-to-narrow in-link converter between the source router and the destination router, in accordance with an example implementation.

FIG. 6 illustrates a flowchart of a method for the narrow-to-wide converter between the source router and the destination router, in accordance with an example implementation.

FIG. 7 illustrates a computer/server block diagram upon which the example implementations described herein may be implemented.

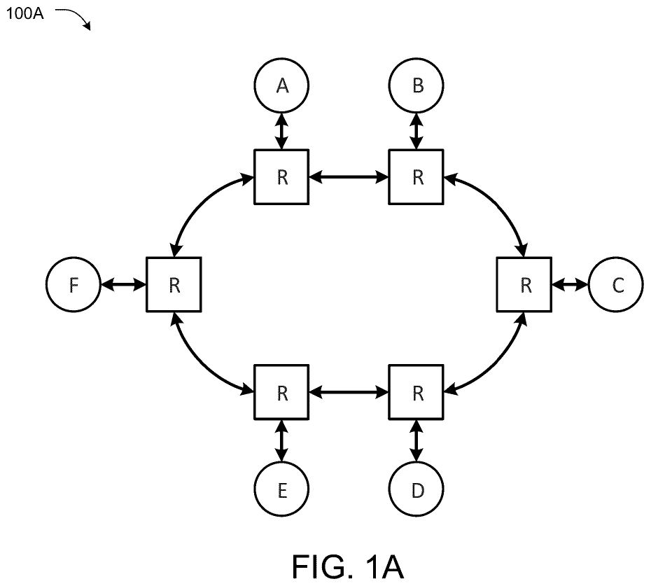

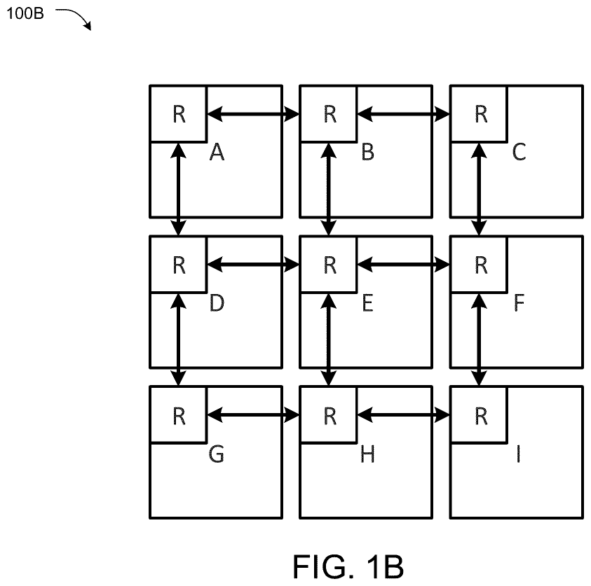

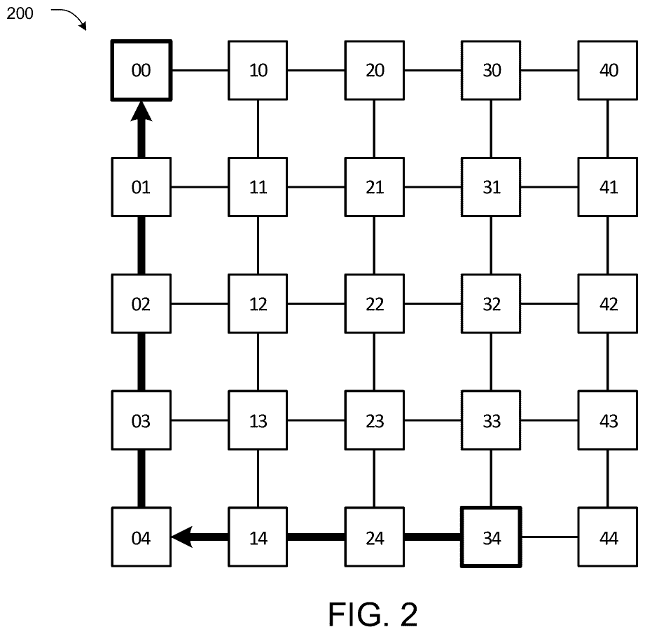

### DETAILED DESCRIPTION

The following detailed description provides further details of the figures and example implementations of the present disclosure. Reference numerals and descriptions of redundant elements between figures are omitted for clarity. Terms used throughout the description are provided as examples and are not intended to be limiting.

Complex traffic profiles in a System-on-Chip (SoC) can create uneven load on various channels of the interconnect that connects various components of the SoC. Example embodiments described herein are based on the concept of constructing interconnect with heterogeneous channel capacities (number of wires) for a specified inter-block communication pattern in the system. An example process of the automatic construction of a Network on Chip (NoC) interconnect is also disclosed.

The load on various channels of NoC interconnect depends upon the rate at which various components are sending messages, the topology of the NoC interconnect, how various components are connected to the NoC nodes, and the path various messages are taking in the NoC. Channels may be uniformly sized in number of wires across the entire NoC to avoid the reformatting of messages within the NoC nodes as they travel over various channels. In such cases case, to avoid congestion, all channels may be sized based on the most loaded channel in the NoC. Load balancing of channels can be performed by routing messages over less loaded paths, which reduces the non-uniform loading of various channels and therefore the maximum load. However, there is limited flexibility in choosing different paths. Route paths can have a variety of restrictions such as using shortest path, using minimal turn, or lack of path diversity between various components. Therefore, in most SoCs, channels remain non-uniformly loaded, and using the highest channel load to determine the global NoC channel width leads to increased area, power and interconnect cost. While having wires of different widths/bandwidths may allow uneven loads to be addressed, such solutions may require routers to have endpoints of different widths. Such solutions require use of adaptors or converters that allow routers having different endpoint sizes to interface with each other. However, in implementation, such converters significantly increase buffering costs, latency, and complexity to the NoC.

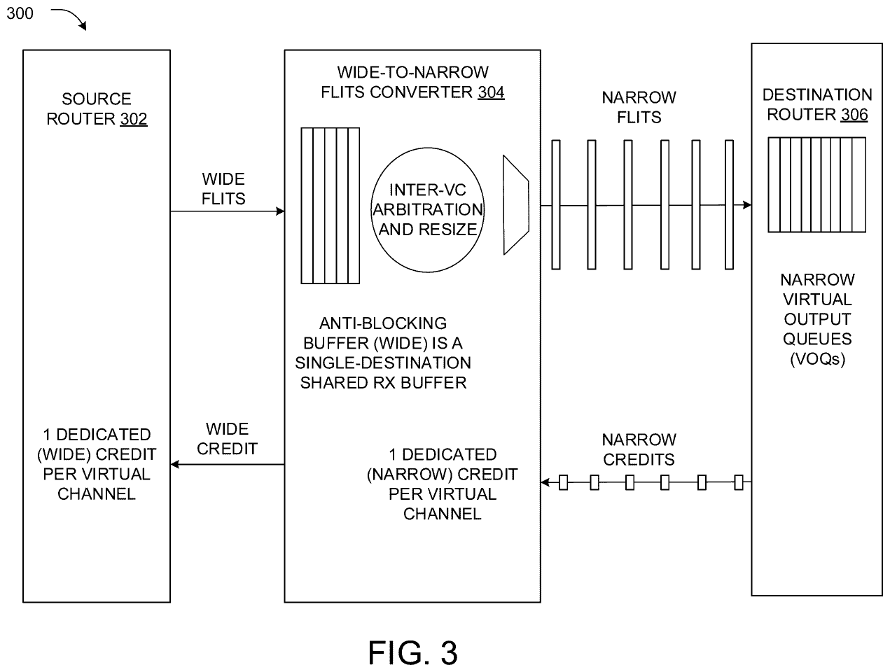

FIG. 3 illustrates a schematic representation 300 of a buffer-based wide-to-narrow converter 304 positioned between a source router 302 and a destination router 306. The wide-to-narrow converter 304 may allow the source router 302 having a wider endpoint to interact with the destination router 306 having a narrower endpoint.

As shown, the wide-to-narrow converter 304 may be positioned close to the source router 302. This proximity minimizes the costs associated with link wires between the source router 402 and the wide-to-narrow converter 304, which are wider to be able to transport wider flits. The wide-to-narrow converter 304 includes a flit buffer with a wide input bandwidth, which is crucial for reducing blocking/congestion back into the wider segments of the network. The wide-to-narrow converter 304 handles wide flits without detecting unused segments of these flits, with the exception of headers. This results in a consistent conversion ratio between wide and narrow flits, such as converting 1 wide flit to 2\acute{ }N narrow flits, for example. When the size of narrow flits is not a factor (i.e. a divisor that leaves no remainder) of the size of the wide flit, portions of the narrow flit may be empty. In such embodiments, the wide-to-narrow converter 304 may manage two credits loops, one with the source router 302 and the other with the destination router 306.

The wide-to-narrow converter 304 may operate by receiving the wide flit from the source router 302. The source router 302 may consume wide credits to transmit the wide flit. The wide-to-narrow converter 304 receives the wide flit, and stored in its input buffer. The wide-to-narrow converter 304 may then convert the wide flit into a plurality of narrow flits. The input buffer may be cleared when the narrow flits are transmitted/popped to the destination router 306. To pop the narrow flits, the wide-to-narrow converter 304 consumes narrow credits received from the destination router 306. The destination router 306 may receive and store the narrow flits in its buffer. When the destination router 306 clears the narrow flits from its buffer, the destination router 306 may return narrow credits (in proportion to the number of narrow credits cleared) to the wide- to-narrow converter 304, thereby indicating that the destination router 306 can receive more narrow credits from the wide-to-narrow converter 304. The destination router 306 may clear its buffer by consuming the narrow flits by sending them to a processing element/host corresponding to the destination router 306, discarding the narrow flits on processing, or further transmitting the narrow flits to other routers to the NoC, but not limited thereto. The wide-to-narrow converter 304 may receive the narrow credits, which, as mentioned earlier, may be consumed to send further narrow flits to the destination router 306. Once the input buffer of the wide-to-narrow converter 304 is cleared, the wide-to-narrow converter 304 may return a wide credit to the source router 302, thereby allowing the source router 302 to send further wide credits to the wide-to-narrow converter 304. The narrow and wide credits may be dedicated credits, i.e. credits that can only be consumed by the VCs to which they are dedicated to.

If the flit includes a serial header, there may be no need for conversion if the header is already sufficiently narrow, a characteristic that remains a fixed constant for every converter. When it comes to converting a parallel-header flit to a serial-header flit, the first wide flit is split into a series of header and payload flits. Conversely, converting a serial-header to a parallel-header presents more complexity. In this scenario, the initial narrow flit conversion might require 1, 2, or even 3 wide flits, depending on whether it's handling a header (H), a header with payload (HP), or multiple headers (HH, HHP). This necessitates a per-virtual-channel reconstruction word, equivalent to one header's width, to effectively manage this conversion process.

Existing NoC (such as those implementing wide-to-narrow converter 304 of FIG. 3, or those that implement wide-to-narrow converters within their routers) experiences significant buffering costs when converting wide flits to narrow flits, and vice versa, and while handling credits for both upstream and downstream sides of the converter. The converters in such implementations typically require multiple buffers to be managed (such as for receiving and converting wide flits from the source router 302, and for receiving and accumulating narrow credits from the destination router 306). While incorporation of separate components that perform conversions between wide flits and narrow flits is desirable (i.e. when converters are placed outside the router such as the wide-to-narrow converter 304) such that the need for modifying existing components is minimized while also providing for modularity and lowered buffering costs, the introduction/use of multiple virtual channels (VCs) and use of dedicated credits for each of the VCs makes the conversion process becomes non-trivial, adds to complexity to the system, and increases buffering costs during the conversion process. Therefore, there is a need for converting packets shared in the NoC between wide flits and narrow flits while minimizing buffering costs brought about by a complexity-enhanced conversion process in a hardware system that contains routers having endpoints with different widths.

Unlike related art systems, the present disclosure relates to systems, and methods for converting between wide and narrow flits. The system includes a wide-to-narrow in-link converter designed for a NoC. The wide-to-narrow in-link converter receives a wide flit from the source router and converts the wide flits into a plurality of narrow flits. These narrow flits are then popped and sent to the destination router, accompanied by the return of a link credit to the source router. Throughout the disclosure, “pop”, “popping”, “popped”, and other variations thereof may mean removing a data element from a data structure. Once the data element is popped, the data element may be transmitted to, processed by, or stored in any one of the components (such as a destination router) of the NoC/System on Chip (SoC). The wide-to-narrow converter further accumulates narrow flit credits received from the destination router, and return a wide flit credit to the source router when the accumulated narrow flit credits match the wide flit credit.

Additionally, the present disclosure also provides a wide-to-narrow in-link converter that is configured to receive different types of wide flits from the source router, and convert the received wide flits into narrow flits, and subsequently pop narrow flits to the destination router. The present disclosure further provides a wide-to-narrow converter configured to receive wide flits from a source router, determine if its buffer is empty or not empty. The wide-to-narrow converter may, when the buffer is empty convert the wide flit into multiple narrow flits, or discard the wide flit and pop the narrow flits in the buffer, if the buffer is not empty. In the aforementioned embodiments, narrow credits are returned from the destination router to the source router.

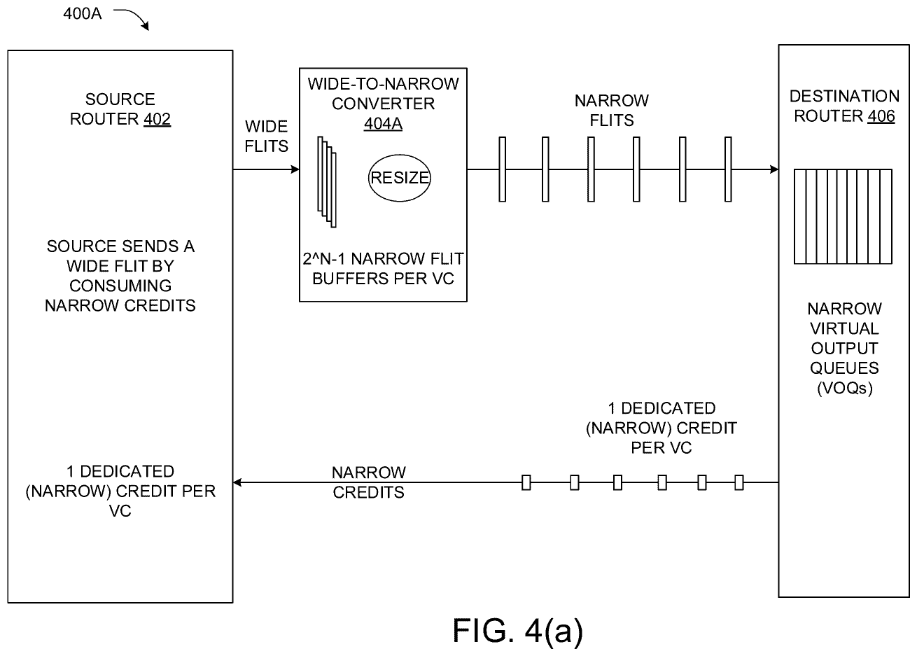

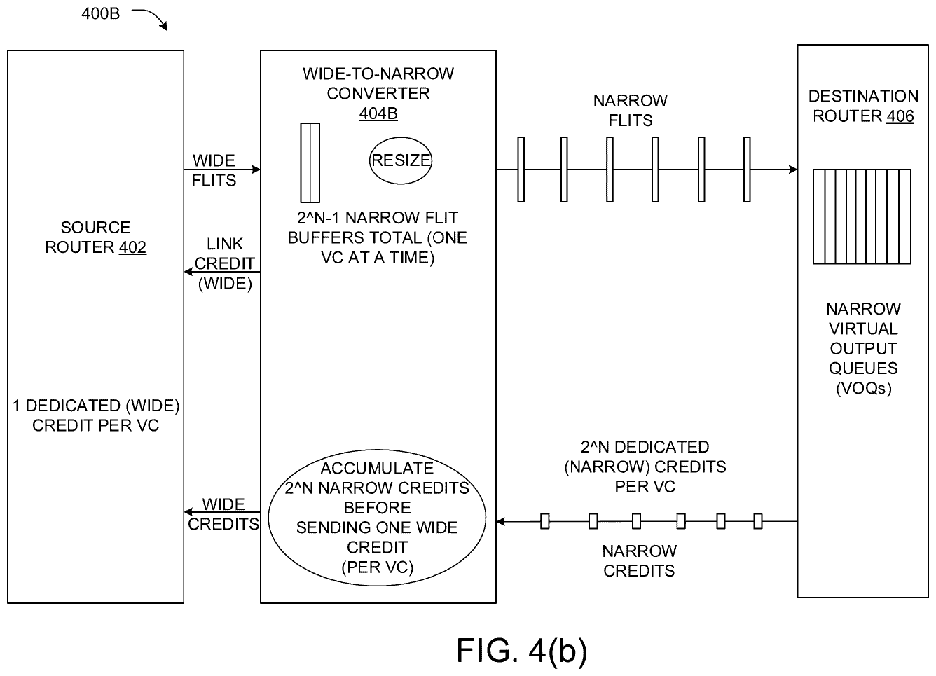

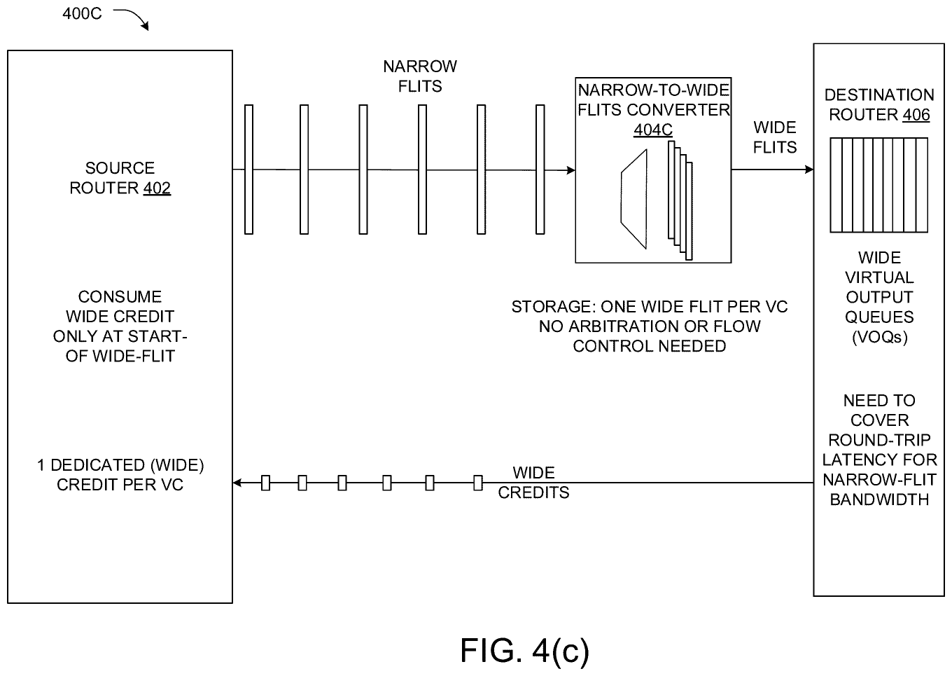

Further, the present disclosure also provides a system for using a narrow-to-wide converter. The present disclosure also relates to a narrow-to-wide in-link converter that is configured to accumulate narrow flits from the source router, convert the accumulated narrow flits into a wide flit, and pop the wide flit to the destination router, thereby enhancing the efficiency and adaptability of communication within the NoC, and addressing the limitations of conventional methods. Various embodiments with respect to the present disclosure will be explained in detail with reference to FIGS. 4(a)-7.

FIG. 4(a) illustrates a schematic representation 400A of a wide-to-narrow converter 404A positioned between a source router 402 and a destination router 406 where narrow credits are sent from the destination router to the source router, in accordance with an example implementation.

As shown, the wide-to-narrow converter 404A may receive a wide flit from the source router 402. Upon receiving a wide flit from the source router 402, the wide-to-narrow converter 404A (e.g., wide-to-narrow in-link converter) may initiate the conversion process. The conversion may include transforming/resizing/splitting the received wide flit into plurality of narrow flits, which are then transmitted/popped to the destination router 406. This conversion enhances the adaptability of the NoC since the wide-to-narrow converter 404A may suitably convert the wide flits into the narrow flits to optimally transmit the data from the source router 402 to the destination router 406, thereby allowing for the seamless transfer of data across the NoC having routers with endpoints of different sizes. In some embodiments, the wide-to-narrow converter 404A may be configured to pop the narrow flits immediately after conversion, thereby eliminating the need for maintaining an input buffer within the wide-to-narrow converter 404A.

The wide-to-narrow converter 404A may iteratively pop the narrow flits to the destination router 406. The destination router 406 may receive and process the narrow flits. The narrow flits received may be stored in a buffer associated with the destination router 406. When the destination router 406 clears (by consuming or popping) the narrow flits from its buffer, the destination router 406 may return narrow credits to the source router 402 indicating that the destination router 406 has space to receive further narrow flits. The narrow credits may be either shared credits (which are shared by one or more of the VCs between the source router 402 and the destination router 406), or dedicated credits (where each dedicated credit is associated with one VC). This distinction is based on the VC utilized for transmitting the narrow flits. The determination of whether the narrow credit is shared or dedicated may be made on receipt at the source router 402.

In some embodiments, the source router 402 may be configured to receive, and accumulate, narrow flit credits returned by the destination router 406. In such embodiments, the source router 402 may include a credit counter or an accumulator that accumulates the narrow credits, or tracks the number of narrow credits received from the destination router 406.

In such embodiments, since the narrow credits are directly sent to the source router 402, the wide-to-narrow converter 404A may not know that the destination router 406 is available to receive further narrow credits (or that its buffer is clear). To indicate to the wide-to-narrow converter 404A that the buffer in the destination router 406 is available, flow control information may be transmitted through the wide flit to the wide-to-narrow converter 404A. The flow control information may be indicative of a dummy flit, or a string of 0 bits, or random bits that the wide-to-narrow converter 404A can recognize as indication that the destination router 406 can accept more narrow flits. Wide flits having the intended data to be transmitted may be referred to as first type of wide flits and the wide flits having the flow control information may be referred to as the second type of wide flits.

In an embodiment, the wide-to-narrow converter 404A may receive either a first type of wide flit or a second type of wide flit from the source router 402. The second type of wide flit may be different from the first type of wide flit. The first and the second types of wide flits may be differentiated by the wide-to-narrow converter 404A based on at least one of size, purpose (i.e. information carried in the wide flits), source router 402 and destination router 406 thereof, and the like, but not limited thereto. Upon reception of the first type of wide flit, the wide-to-narrow converter 404A may convert the first type of wide flit to a plurality of narrow flits. In an embodiment, upon reception of the second type of wide flit, the wide-to-narrow converter 404A may pop one of the narrow flits to the destination router 406. In some embodiments, a combination of the first and second type of wide flit may be sent to the wide-to-narrow converter 404A, where the flit includes both data and the flow control information. In such embodiments, the wide-to-narrow converter 404A may convert the first type of wide flit into a plurality of narrow flits and pop them to the destination router 406. The wide-to-narrow converter 404A may also discard the second type of wide flit, thereby ensuring that only the relevant data is forwarded to the destination.

In other embodiments, the source router 402, the wide-to-narrow converter 404A, and the destination router 406 may have a shared understanding of the space availability in the buffer of the destination router 406. The wide-to-narrow converter 404A may pop the narrow flits to the destination router 406 based on whether the input buffer is empty or is not empty when a wide flit is received from the source router 402. In an embodiment, when the wide-to-narrow converter 404A receives the first wide flit, the wide-to-narrow converter 404A converts the first wide flit to the plurality of narrow flits. In an embodiment, for each subsequent wide flit received from the source router 402, the wide-to-narrow converter 404A may determine if the buffer of the wide-to-narrow converter 404B is empty or not. In instances where the buffer is not empty, the wide-to-narrow converter 404A pops a narrow flit from the plurality of narrow flits in the buffer to the destination router 406. Further, the subsequent wide flit by the wide-to-narrow converter 404A is discarded, thereby clearing the buffer. In some embodiments, the subsequent wide flit may be used by the source router 402 to indicate to the wide-to-narrow converter 404A that the destination router 406 has space available in its buffer to receive narrow credits. On the other hand, when the buffer is found to be empty, the wide-to-narrow converter 404A converts the subsequent wide flit into another plurality of narrow flits. The wide-to-narrow converter 404A may store another plurality of narrow flits into the buffer, thereby preparing for subsequent transmission to the destination router 406. This systematic approach optimizes the utilization of the buffer and ensures a seamless flow of data through the NoC. In an embodiment, each subsequent wide flit may be received from the same virtual channel.

In some examples, the first wide flit (e.g., of 256 bits) may be received by the wide-to-narrow converter 404A. Upon reception, the wide-to-narrow converter 404A may convert the 256-bit wide flit into the plurality of narrow flits, which are then stored in a buffer. As subsequent wide flits, each including 256 bits, arrive from the source router 402, the wide-to-narrow converter 404B may determine whether its buffer is empty or not. If the buffer is not empty, indicating the presence of previously converted narrow flits, the wide-to-narrow converter 404A pops the narrow flits in the buffer to the destination router 406. Simultaneously, the subsequent 256-bit wide flit is discarded. Conversely, if the buffer is empty, the wide-to-narrow converter 404A converts the subsequent wide flit into another plurality of narrow flits, which are stored in the buffer to be ready for subsequent transmission to the destination router 406. In some embodiments, wide-to-narrow converter 404A may be positioned near the source router 402 to minimize the link wire costs associated with data transmission which may be significant in complex network architectures. Furthermore, the wide-to-narrow converter 404A does not attempt to detect unused parts of wide flits, with the exception of headers. In some examples, the wide-to-narrow converter 404A may be configured to convert each wide flit into 2N narrow flits. However, it may be appreciated by those skilled in the art that the wide-to-narrow converter 404A may convert the wide flits into any number of narrow flits.

In an embodiment, in the wide-to-narrow converter 404A, a number of buffer spaces are available for each VC. At least narrow flit may be transmitted to the destination router 406 on conversion. In such instances, the wide-to-narrow converter 404A requires one less than 2^{N} buffers, for each VC. In some examples, the (2^{N})-1 may indicate that the number of buffers is one less than a power of two. For instance, if N=3, there may be (2³)-1, or 7, narrow flit buffers for each VC. These buffers temporarily store the narrow flits that result from splitting a wide flit during conversion before they are sent to the destination router 406.

In exemplary embodiments, each VC may be allocated exactly one dedicated narrow credit. In an embodiment, when the source router 402 sends the wide flit, it immediately follows it with a sequence of dummy flits. These dummy flits are sent on the same VC and consume narrow credits. This may be part of a mechanism to ensure that the wide flit is broken down into narrow flits correctly and that each part of the wide flit has a corresponding credit to be processed individually.

FIG. 4(b) illustrates a schematic representation 400B of the wide-to-narrow converter 404A positioned between the source router 402 and the destination router 406 where narrow credits are sent from the destination router to the converter, in accordance with an example implementation.

As shown, the wide-to-narrow converter 404B may be configured to receive data in form of the wide flits from the source router 402 and convert the data into narrow flits for transmission to the destination router 406. The source router 402 may be configured to consume a link credit and a wide credit (either shared or dedicated) to send the wide flit to the wide-to-narrow converter 404B. The wide-to-narrow converter 404B may receive and convert/resize the flits because different parts of the NoC may operate with flits of different sizes, and the conversion may ensure compatibility and maintains the efficiency of data traffic across the NoC. The wide-to-narrow converter 404B may have an input buffer to receive and store the wide flits. After conversion, the wide-to-narrow converter 404B may pop the narrow flits to the destination router 406. The wide-to-narrow converter 404B may consume narrow credits therein to pop the narrow flits. On popping the narrow flits and clearing the input buffer, the wide-to-narrow converter 404B may return a link credit to the source router 402. Further, the destination router 406 may be configured to receive the narrow flits from the wide-to-narrow converter 404B. The destination router 406 may maintain its own buffer for receiving the narrow flits, which may be cleared (either through consumption or further popping to other routers). When the destination router 406 becomes available to receive further narrow flits, the destination router 406 may return narrow credits to the wide-to-narrow converter 404B. The wide-to-narrow converter 404B may accumulate the narrow credits, and return a wide credit to the source router 402 when the number of narrow credits accumulated is equivalent to the wide flit credit.

In some embodiments, after a predefined number of cycles before transmitting/popping all narrow flits, the wide-to-narrow converter 404B may return a link credit to the source router 402. Returning of the link credit may indicate to the source router 402 that the wide-to-narrow converter 404B has space in its buffer to receive additional wide flits. Further, by returning the link credit after the predefined number of cycles (instead of waiting for all narrow flits to be popped), the wide-to-narrow converter 404B may save at least one cycle. For example, if the wide-to-narrow converter 404B splits 1 wide flit into 4 narrow flits, and in each cycle subsequent to the conversion one narrow flit is popped, the wide-to-narrow converter 404B may be configured to return the link credit on the 4^{th} cycle subsequent to the conversion (i.e. along with the last narrow flit popped), as opposed to sending the link credit on the 5^{th} cycle. The predefined number may also be selected based on the number of cycles required by the source router 402 to prepare the data/wide flit to be sent to the wide-to-narrow converter 404B. For example, the source router 402 takes 2 cycles to prepare and transmit the wide flit to the wide-to-narrow converter 404B, the wide-to-narrow converter 404B may send the link credit in the cycle where the second last narrow flit is popped from the wide-to-narrow converter 404B to the destination router 406 (i.e. the 3rd cycle subsequent to the conversion in the aforementioned example).

In some examples, if the wide-to-narrow converter 404A receives the 256-bit wide flit from the source router 402, the wide-to-narrow converter 404A transforms the wide flit into the plurality of narrow flits. In this instance, the conversion process results in 32 narrow flits, each consisting of 8 bits. These 32 narrow flits, denoted as narrow flit 1 through narrow flit 32, are then transmitted to the destination router 406. As the wide-to-narrow converter 404A operates for a defined number of cycles, the wide-to-narrow converter 404A actively manages the credit system, particularly focuses on the VCs. As part of this process, the wide-to-narrow 404A may accumulate the narrow flit credits on a per-VC basis. For instance, if, within the specified cycles, 20 narrow flits are successfully transmitted to the destination router 406, the wide-to-narrow converter 404A returns the link credit of 20 to the source router 402. Furthermore, if the accumulated narrow flit credits for a particular VC reach a total of 128 bits, equivalent to half of the wide flit (256 bits), the wide-to-narrow converter 404A returns the wide flit credit to the source router 402. In this case, the source router 402 does not directly receive narrow flit credits but relies on the wide-to-narrow converter 404A to manage and communicate these credits on the per-VC basis. In some examples, the destination router 406 may directly send the narrow flit credits back to the source router 402 as each narrow flit is successfully received.

In an embodiment, the wide-to-narrow converter 404A may return a wide flit credit to the source router 402. In such embodiments, the wide flit credit may be transmitted when the accumulated narrow flit credits is equivalent to a specified threshold. The threshold may correspond to the size of the wide flit. For example, if the ratio between the sizes of the wide flit (received from the source router 402), and the converted narrow flits is in the ratio 1:4, then the accumulator may wait until 4 narrow credits are received from the destination router 406 before sending the wide flit credits to the source router 402. The wide flit credit may allow the source router 402 to transmit further wide flits to the wide-to-narrow converter 404A. The source router 402 may be configured to send further wide flits when it has both a link credit (which indicates the buffer of the converter 404A is available) and a wide flit credit (which indicate the buffer in the destination router 406 is available). Additionally, the wide flit credit may be configured as either a shared credit or a dedicated credit. This distinction is based on the virtual channel utilized for transmitting the narrow flits.

Each VC in the wide-to-narrow converter 404B has a specific number of buffers to hold the narrow flits. If the wide flit is converted to 2^{N} narrow flits and one narrow flit is popped immediately on conversion, then number of buffers is one less than 2^{N}, for example. Either 2^{N}-1 buffers may be used, or buffers capable of storing 2N-1 buffers may be used. The buffers may be implemented as First-in-First-out (FIFO buffers). These buffers may store the narrow flits temporarily until the narrow flits can be sent on to the destination router 406. This conversion process does not attempt to detect unused parts of the wide flits (except headers). This implies a straightforward approach to handling data where the wide-to-narrow converter 404A consistently operates on a 1-in-2^{N}-out basis. This means for every wide flit received, the wide-to-narrow converter 404A may output a predetermined number of narrow flits (2^{N}), regardless of the actual data content of the wide flit. More buffers (i.e. in addition to the 2^{N}-1) may be implemented to handle link credits, for example, to avoid delays in sending the link credits or when more than one link credits are to be sent to the source router 404, to provide anti-blocking functionality, and the like.

In an embodiment, the source router 402 may have one dedicated (wide) credit per VC which allows the source router 402 to send the wide flit through the VC when the credit is available. Conversely, the destination router 406 sends 2N dedicated (narrow) credits per VC. These narrow credits correspond to the destination router's 406 capacity to receive the narrow flits. The wide-to-narrow converter 404A may accumulate with a 2N narrow credits before sending one wide flit. This may require the source router 402 to wait until there is sufficient capacity at the destination router 406 to handle the narrow flits that may be generated from a single wide flit.

FIG. 4(c) illustrates a schematic representation 400C of a narrow-wide converter 404C positioned between a source router 402 and a destination router 406, in accordance with an example implementation.

Referring to FIG. 4(c), the narrow-to-wide converter 404C may accumulate one or more narrow flits from the source router 402. In some embodiments, the narrow-to-wide converter 404C may convert accumulated narrow flits into a wide flit. In some embodiments, the narrow-to-wide converter 404C may be configured to conduct conversion of the accumulated narrow flits when an end-of-packet is detected within the narrow flits. In such embodiments, if the cumulative size of the narrow flits having the end-of-packet is less than the size of the wide flit, such narrow flits may be included in the wide flit and the space remaining in the wide flit may be left empty. In some examples, the narrow-to-wide converter 404C may be configured such that the Most Significant Bits (MSBs) of the wide flit are set to zero after the end-of-packet. This design may allow for a flexible M-in-1-out conversion ratio, where M can vary from 1, 2 to 2^{N}, for example but not limited thereto, thereby accommodating a range of the wide flit sizes and enabling efficient data processing. In other embodiments, the narrow-to-wide converter 404C may be configured to conduct conversion of the accumulated narrow flits when size of the accumulated narrow flits is equivalent to the maximum size of the wide flit that can be popped from the narrow-to-wide converter 404C to the destination router 406.

Once the narrow flits are converted into the wide flit, the narrow-to-wide converter 404C may be configured to pop the wide flit to the destination router 406. After the popping, the destination router 406 may receive and store the wide flit in its buffer. When the destination router 406 clears its buffer (such as be processing, further popping/transmitting/or consuming by sending the wide flit to a processing element thereof), the destination router 406 may return the wide credit back to the source router 402, indicating that the destination router 406 is available/has space for receiving wide flits. The source router 402 may consume the wide flits to send a number of narrow flits to the narrow-to-wide converter 404C, the number corresponding to an upsized ratio between sizes of the narrow and the wide flits. In some embodiments, the source router 402 may send a number of narrow flits whose cumulative size is at most the size of the wide flit that the destination router 406 can receive.

In some embodiments, the narrow-to-wide converter 404C may be configured to manage different buffers, each buffer corresponding to different virtual channel between the source router 402 and the destination router 406. Moreover, the wide credit is set as either a shared credit or a dedicated credit based on the virtual channel used for the popping operation, providing a tailored approach to credit allocation in the communication system.

In exemplary embodiments, where there may be a consideration for round-trip time and the conversion (or upsize) ratio between wide and narrow flits, these factors may determine the overall performance and bandwidth optimization of the NoC. Specifically, if the round-trip time i.e., the time it takes for data to travel from the source router 402 to the destination router 406 and destination router 406 to the source router 402 is 12 cycles, and there is a conversion factor of 2× when upsizing narrow flits to wide flits, the source router 402 may be capable of sending 12 narrow flits for every 6 wide credits it has. This is because each wide credit is equivalent to 2 narrow flits (due to the 2× upsize factor). As a result, to accommodate this data without loss, the receiver (RX) at the destination router 406 may need a buffer depth of 6. This buffer depth may ensure that all 12 incoming narrow flits may be temporarily stored if needed, and that there is enough space to handle the flits until they can be processed, acknowledging the credits consumption in alignment with the round-trip delay and upsizing factor.

In an embodiment, the narrow-to-wide converter 404C may configured with a storage and transmission protocol. Each VC may hold space for one wide flit, eliminating the need for arbitration for determining which VC can share the wide flits to the narrow-to-wide converter 404C, and/or eliminate the need for flow control (crediting between the narrow-to-wide converter 404C and the source router 402. In such embodiments, the wide flit converted in the narrow-to-wide converter 404C is transmitted/popped as soon as it is ready, thereby streamlining the process.

Further, the narrow-to-wide converter 404C may positioned close to the destination router 406 to minimize the cost associated with link wires by minimizing length of link wires having higher bandwidth (i.e. link wires that allow transmission of wider flits).

In an embodiment, the narrow-to-wide converter 404C may deal with header conversions, the conversion process may vary based on the header type. For serial-headers that are sufficiently narrow, and may not require conversion. This scenario necessitates that both the source router 402 and the narrow-to-wide converter 404C may be configured to recognize and appropriately manage such narrow headers without conversion, a capability that is standardized across all router/converter pairs. When the conversion involves changing a serial-header to a parallel-header, the adjustment may typically straightforward. However, it does require the addition of one or two extra narrow flits, which may not affect the credit system.

In an embodiment, converting the parallel-header to the serial-header may be more complex. In this process, it is often the case that the first narrow flit is transformed into one or two wide flits. Additionally, the beginning, and potentially the whole, of the subsequent flit may require an increase in wide credits that potentially one, two, or even three, depending on the situation. As a result, there is a need for two or three dedicated credits per VC to accommodate this conversion. Such an increase in credit requirements may lead to a decrease in bandwidth, which in turn might cause back-pressure within the narrow network segments. Although the impact of such back-pressure is a critical concern. Another issue that may arise is the insufficiency of the narrow-to-wide converter 404C output bandwidth, particularly in situations where the data stream comprises only headers or a first-payload with an end-of-packet indicator. Such scenarios may result in an inefficient conversion where one narrow flit expands into two wide flits. To rectify this, the source router 402 may de-assert the “valid” signal in these instances, thus utilizing a number of cycles that matches the number of wide flits produced. It is uncertain if this situation commonly occurs, especially in systems utilizing the Advanced extensible Interface (AXI) protocol, where the construction of headers spanning multiple flits is an uncommon occurrence, typically restricted to the narrowest of data widths.

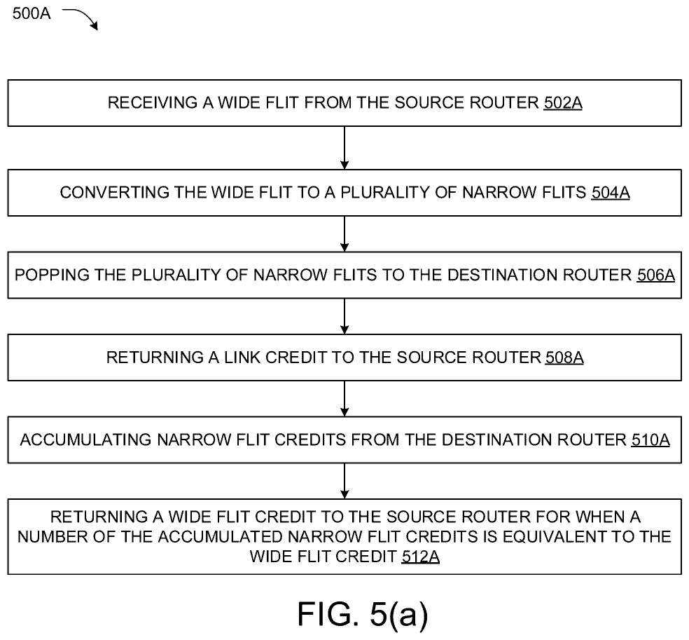

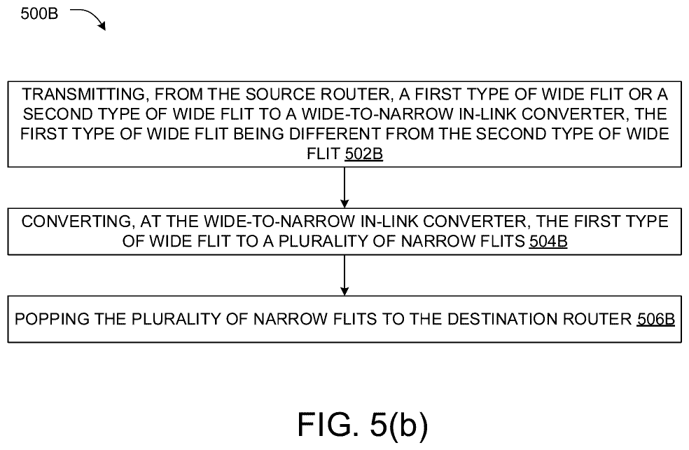

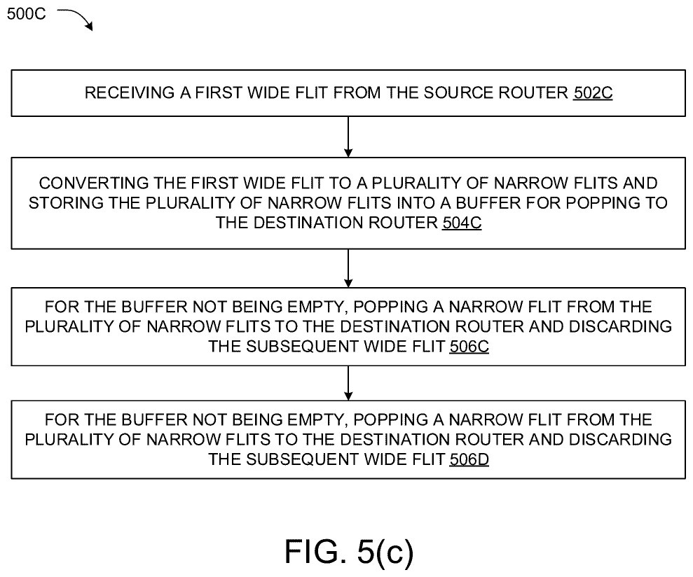

FIGS. 5(a), 5(b), and 5(c) illustrate flowcharts of methods 500A, 500B, and 500C for a wide-to-narrow in-link converter (e.g., 404A) between a source router (e.g., 402) and a destination router (e.g., 406), in accordance with an example implementation.

Referring to FIG. 5(a), at block 502A, the method 500A may include receiving a wide flit from the source router 402. At block 504A, the method 500A may include converting the wide flit to a plurality of narrow flits. At block 506A, the method 500A may include popping the plurality of narrow flits to the destination router 406. At block 508A, the method 500A may include returning a link credit to the source router 402. At block 510A, the method 500A may include accumulating narrow flit credits from the destination router 406. The narrow flits credits may be received from the destination router 406, the destination router 406 sending the narrow flit credits to indicate it can receive further narrow flits. At block 512A, the method 500A may include returning a wide flit credit to the source router 402 for when a number of the accumulated narrow flit credits is equivalent to the wide flit credit. In an embodiment, the link credit is returned to the source router 402 is conducted after a defined number of cycles before all of the narrow flits are popped.

Referring to FIG. 5(b), at block 502B, the method 500B may include transmitting, from the source router 402, a first type of wide flit or a second type of wide flit to the wide-to-narrow in-link converter 404A, the first type of wide flit being different from the second type of wide flit. At block 504B, the method 500B may include converting, at the wide-to-narrow in-link converter 404A, the first type of wide flit to a plurality of narrow flits. At block 506B, the method 500B may include popping the plurality of narrow flits to the destination router 406. In an embodiment, the wide-to-narrow in-link converter 404A discards the second type of wide flit. In an embodiment, each of the narrow flit credits are set as a shared credit or a dedicated credit based on a virtual channel used to pop the plurality of narrow flits.

Referring to FIG. 5(c), at block 502C, the method 500C may include receiving a first wide flit from the source router 402. At block 504C, the method 500C may include converting the first wide flit to a plurality of narrow flits and storing the plurality of narrow flits into a buffer for popping to the destination router 406. At block 506C, the method 500C may include for the buffer not being empty, popping a narrow flit from the plurality of narrow flits to the destination router 406 and discarding the subsequent wide flit. At block 506D, the method 500C may include for the buffer being empty, converting the subsequent wide flit into another plurality of narrow flits and storing another plurality of narrow flits into the buffer.

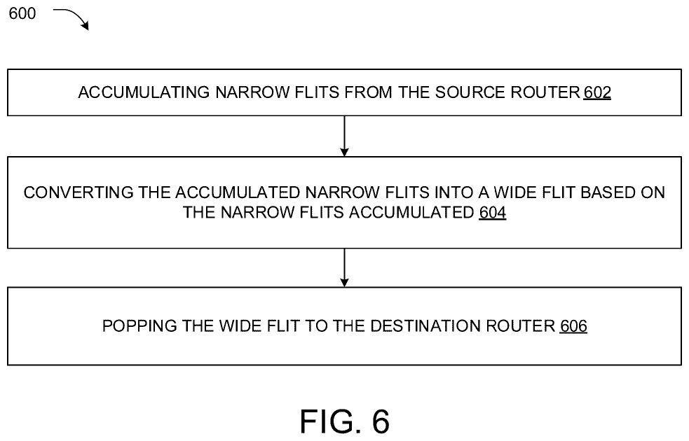

FIG. 6 illustrates a flowchart of a method 600 for the narrow-to-wide converter 404C between a source router 402 and a destination router 406, in accordance with an example implementation.

Referring to FIG. 6, at block 602, the method 600 may include accumulating narrow flits from the source router 402. At block 604, the method 600 may include converting the accumulated narrow flits into a wide flit based on the narrow flits accumulated. In an embodiment, the source router 402 transmits a number the narrow flits to the narrow-to-wide converter 404C corresponding to an upsized ratio in response to receipt of a wide credit. In an embodiment, the method 600 may include converting the accumulated narrow flits into the wide flit based on the narrow flits accumulated comprises conducting the conversion of the accumulated narrow flits when an end of packet is detected in the narrow flits. At block 606, method 600 may include popping the wide flit to the destination router 406. Aspects of the present disclosure, as described above, may be implemented as computer-implemented methods.

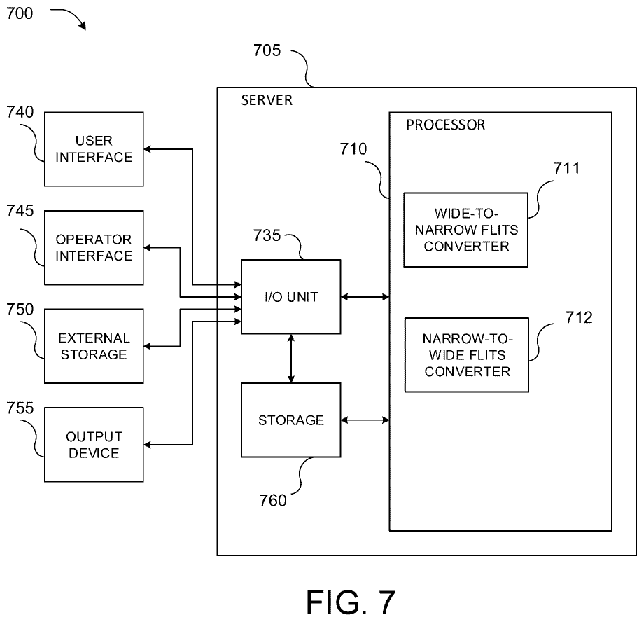

FIG. 7 illustrates an example computer system 700 on which example embodiments of the present disclosure may be implemented. The computer system 700 includes a server 705 which may involve an I/O unit 735, storage 760, and a processor 710 operable to execute one or more units as known to one of skill in the art. The term “computer-readable medium” as used herein refers to any medium that participates in providing instructions to processor 710 for execution, which may come in the form of computer-readable storage mediums, such as, but not limited to optical disks, magnetic disks, read-only memories, random access memories, solid state devices and drives, or any other types of tangible media suitable for storing electronic information, or computer-readable signal mediums, which can include transitory media such as carrier waves. The I/O unit processes input from user interfaces 740 and operator interfaces 745 which may utilize input devices such as a keyboard, mouse, touch device, or verbal command.

The server 705 may also be connected to an external storage 750, which can contain removable storage such as a portable hard drive, optical media (CD or DVD), disk media or any other medium from which a computer can read executable code. The server 705 may also be connected an output device 755, such as a display to output data and other information to a user, as well as request additional information from a user. The connections from the server 705 to the user interface 740, the operator interface 745, the external storage 750, and the output device 755 may via wireless protocols, such as the 802.11 standards, Bluetooth® or cellular protocols, or via physical transmission media, such as cables or fiber optics. The output device 755 may therefore further act as an input device for interacting with a user.

The processor 710 may execute one or more modules. The wide-to-narrow converter 711 (e.g., 404A) may be configured to receive a wide flit from a source router (e.g., 402), which is then converted into multiple narrow flits. Further, the wide-to-narrow converter 711 may pop these narrow flits to the destination router 406, and a link credit is returned to the source router 402. As the destination router 406 receives and processes the narrow flits, narrow flit credits accumulate. Once the accumulated narrow flit credits match the original wide flit credit, the wide-to-narrow converter 711 may return a wide flit credit to the source router 402. The source router 402 may send either a first or second type of wide flit to a wide-to-narrow in-link converter 711, which transforms the first type into multiple narrow flits for subsequent popping to the destination router 406. In case the buffer is not empty, the wide-to-narrow converter 711 may pop narrow flits from the buffer for transmission, otherwise, the subsequent wide flit is converted into another set of narrow flits and stored in the buffer for later popping. This process ensures efficient and synchronized data transfer between routers in a network.

The narrow-to-wide converter 712 (e.g., 404C) may be designed to efficiently manage data transfer between source router 402 and destination router 404. This configuration involves the accumulation of narrow flits from the source router 402. Further, the narrow-to-wide converter 712 may convert the accumulated narrow flits into a wide flit. Once the accumulated narrow flits are converted to a wide flit, the narrow-to-wide converter 712 may pop the wide flit to the destination router 406. The narrow-to-wide converter 712 may return a wide credit to the source router 402 after the wide flit has been popped to the destination router 406, thereby optimizing data flow and resource utilization in the network. The present disclosure, therefore, provides for an in-link flit resizing either from wide flits to narrow flits, or vice-versa, when the flits are transmitted through channels/links between source and destination routers. Further, the present disclosure provides end-to-end exchange of credits with the source and destination routers, thereby allowing for efficient transmission of data there through with minimal buffering.

Furthermore, some portions of the detailed description are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the example embodiments, the steps carried out require physical manipulations of tangible quantities for achieving a tangible result.

Moreover, other implementations of the example embodiments will be apparent to those skilled in the art from consideration of the specification and practice of the example embodiments disclosed herein. Various aspects and/or components of the described example embodiments may be used singly or in any combination. It is intended that the specification and examples be considered as examples, with a true scope and spirit of the embodiments being indicated by the following claims.

What is claimed is:

1. A method for a wide-to-narrow in-link converter between a source router and a destination router of a Network on Chip (NoC), comprising:
receiving a wide flit from the source router;
converting the wide flit to a plurality of narrow flits;
popping the plurality of narrow flits to the destination router;
returning a link credit to the source router;
accumulating narrow flit credits received from the destination router; and
returning a wide flit credit to the source router for when a number of the accumulated narrow flit credits is equivalent to the wide flit credit.

2. The method of claim 1, wherein the returning the link credit to the source router is conducted after a defined number of cycles before all of the narrow flits are popped.

3. The method of claim 1, wherein the wide flit credit is set as a shared credit or a dedicated credit based on a virtual channel utilized to pop the plurality of narrow flits.

4. A system, comprising a wide-to-narrow in-link converter between a source router and a destination router of a Network on Chip (NoC), wherein the wide-to-narrow in-link converter is configured to:
receive a wide flit from the source router;
convert the wide flit to a plurality of narrow flits;
pop the plurality of narrow flits to the destination router;
return a link credit to the source router;
accumulate narrow flit credits received from the destination router; and
return a wide flit credit to the source router for when a number of the accumulated narrow flit credits is equivalent to the wide flit credit.

5. The system of claim 4, wherein the returning the link credit to the source router is conducted after a defined number of cycles before all of the narrow flits are popped.

6. The system of claim 4, wherein the wide flit credit is set as a shared credit or a dedicated credit based on a virtual channel utilized to pop the plurality of narrow flits.

7. A method for a wide to narrow in-link conversion between a source router and a destination router in a Network on Chip (NoC), comprising:
transmitting, from the source router, a first type of wide flit or a second type of wide flit to a wide-to-narrow in-link converter, the first type of wide flit being different from the second type of wide flit;
converting, at the wide-to-narrow in-link converter, the first type of wide flit to a plurality of narrow flits; and
popping the plurality of narrow flits to the destination router.

8. The method of claim 7, wherein the first type of wide flit comprises data to be received by the destination router.

9. The method of claim 7, wherein the wide-to-narrow in-link converter discards the second type of wide flit.

10. The method of claim 7, further comprising returning narrow flit credits from the destination router to the source router.

11. The method of claim 10, wherein each of the narrow flit credits are set as a shared credit or a dedicated credit based on a virtual channel used to pop the plurality of narrow flits.

12. The method of claim 10, wherein the source router consumes the narrow flit credits to transmit the wide flit.

13. The method of claim 7, wherein the popping the plurality of narrow flits to the destination router comprises popping one of the plurality of narrow flits in response to receiving the second type of wide flit.

14. A system, comprising a wide-to-narrow in-link converter between a source router and a destination router in a Network on Chip (NoC), wherein the wide-to-narrow in-link converter is configured to:
receive a first type of wide flit or a second type of wide flit from the source router, the first type of wide flit being different from the second type of wide flit;
convert the first type of wide flit to a plurality of narrow flits; and
pop the plurality of narrow flits to the destination router.

15. The system of claim 14, wherein the first type of wide flit comprises data to be received by the destination router.

16. The system of claim 14, wherein the wide-to-narrow in-link converter discards the second type of wide flit.

17. The system of claim 14, wherein the narrow flit credits are returned from the destination router to the source router.

18. The system of claim 17, wherein each of the narrow flit credits are set as a shared credit or a dedicated credit based on a virtual channel used to pop the plurality of narrow flits.

19. The system of claim 17, wherein the source router consumes the narrow flit credits to transmit the wide flit.

20. The system of claim 14, wherein the wide-to-narrow in-link converter is to pop the plurality of narrow flits to the destination router comprises popping one of the plurality of narrow flits in response to receiving the second type of wide flit.
